(19) United States
(12) Patent Application Publication
(10) Pub. No.: US 2009/0020225 A1
(43) Pub. Date: Jan. 22, 2009

(54) AUTOADHESIVE

(75) Inventors: Dirk Wulff, Schifferstadt (DE); Axel Weiss, Speyer (DE); Jose Maria Torres Llosa, Ludwigshafen (DE); Christofer Arisandy, Mannheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/162,433

(22) PCT Filed: Jan. 23, 2007
(86) PCT No.: PCT/EP07/50637

§ 371 Date: Jul. 28, 2008

(30) Foreign Application Priority Data
Jan. 30, 2006 (EP) 06101011.2
Mar. 30, 2006 (EP) 06112021.8

(51) Int. Cl. B32B 27/04; C08F 120/18

(52) U.S. Cl. 156/332; 526/329.7; 428/482

(57) ABSTRACT

The use of a composition of low or no tack at 20° C. as an adhesive that can be adhered to itself (referred to below for short as an autoadhesive).

The invention relates to the use of a composition of low or no tack at 20° C. as an adhesive that can be adhered to itself (referred to below for short as an autoadhesive).

Pressure-sensitive adhesives are permanently tacky. For many applications there is a desire for adhesive-coated substrates which in the course of storage and transport are initially nontacky, i.e., are blocking-resistant. Those known include, for example, hotmelt adhesives, which are nontacky at room temperature and are processed only at high temperatures.

Emulsion polymers of multistage construction for the adhesive utility are described for example in EP-A 1 420 055. The disclosure includes in particular a butyl acrylate (BA) and methyl methacrylate (MMA) copolymer obtained by multistage polymerization. BA and MMA are copolymerized in a first stage to give a product to which after 15 minutes (at 90° C.) further MMA is added without initiator. MMA diffuses into the copolymer, where it polymerizes (this process also being referred to as swelling polymerization). The copolymer obtained after swelling polymerization is tacky.

An object of the present invention were blocking-resistant adhesives which are tacky only under certain conditions. The conditions ought as far as possible to be moderate. Moreover, the adhesives ought to have good performance properties.

Accordingly the use defined at the outset has been found.

The composition used in accordance with the invention is of low or no tack at room temperature.

A polyester substrate (polyethylene terephthalate, PET) coated with the composition has an adhesion to steel at 20° C. of in particular less than 0.5 N/2.5 cm, more preferably less than 0.2 N/2.5 cm.

The adhesion here is determined by the following measurement method (quickstick value):

The dispersions or solutions of the polymer are knifecoated at 30 g/m2 (solids) onto sections of PET film 25 mm wide and drying is carried out at 90° C. for 3 minutes.

The quickstick value was determined by clamping both ends of a test strip 17.5 cm long and 2.5 cm wide into the jaws of a tensile machine to form of loop which is then contacted with a chromed steel surface at a rate of 30 cm/min (lowering of the loop onto the chromed steel plate). When contact has been achieved over the full area, a contact time of 1 minute is allowed, after which the loop is removed again, the maximum force measured in the course of the removal, in N/2.5 cm, being defined as the measure of the quickstick value. The measurement is conducted at 20° C. and 50% relative humidity.

The value obtained is a measure of the adhesion and hence of the tack.

Correspondingly, a PET substrate coated with the composition also has a peel strength on steel at 20° C. of less than 0.5 N/2.5 cm, more preferably less than 0.2 N/2.5 cm; the peel strength is determined by the following measurement method:

The test strips are produced as described above. To determine the peel strength (adhesion) a test strip 2.5 cm wide is bonded to a chromed V2A stainless steel test plate and rolled on once using a roller weighing 1 kg. It is then clamped by one end into the upper jaws of a tension/extension testing apparatus. The adhesive strip is removed at 300 mm/min and at an angle of 180° from the test surface (V2A stainless steel)—that is, the adhesive strip was bent around and removed parallel to the metal test plate, with measurement of the force required to achieve removal. The measure of the peel strength is the force in N/2.5 cm which resulted as the average value from five measurements (this corresponds to the AFERA standard method). The peel strength is determined immediately after bonding.

The composition preferably comprises an aqueous polymer dispersion as binder.

The polymer dispersed in the dispersion is obtainable by free-radical polymerization of ethylenically unsaturated compounds (monomers).

The polymer is composed preferably of at least 60% by weight, more preferably at least 80% by weight, very preferably at least 90% by weight of what are called principal monomers.

The principal monomers are selected from C₁-C₂₀ alkyl (meth)acrylates, vinyl esters of carboxylic acids comprising up to 20 C atoms, vinylaromatics having up to 20 C atoms, ethylenically unsaturated nitriles, vinyl halides, vinyl ethers of alcohols comprising 1 to 10 C atoms, aliphatic hydrocarbons having 2 to 8 C atoms and one or two double bonds, or mixtures of these monomers.

Mention may be made, for example, of (meth)acrylic acid alkyl esters with a C₁-C₁₀ alkyl radical, such as methyl methacrylate, methyl acrylate, n-butyl acrylate, ethyl acrylate, and 2-ethylhexyl acrylate.

Also suitable in particular are mixtures of the (meth)acrylic acid alkyl esters.

Vinyl esters of carboxylic acids having 1 to 20 C atoms are, for example, vinyl laurate, vinyl stearate, vinyl propionate, Versatic acid vinyl esters, and vinyl acetate.

Suitable vinylaromatic compounds include vinyltoluene, a- and p-methylstyrene, a-butylstyrene, 4-n-butylstyrene, 4-n-decylstyrene, and, preferably, styrene. Examples of nitriles are acrylonitrile and methacrylonitrile.

The vinyl halides are chloro, fluoro or bromo-substituted ethylenically unsaturated compounds, preferably vinyl chloride and vinylidene chloride.

As vinyl ethers mention may be made for example of vinyl methyl ether or vinyl isobutyl ether. Preference is given to vinyl ethers of alcohols comprising 1 to 4 C atoms.

As hydrocarbons having 4 to 8 C atoms and two olefinic double bonds mention may be made of butadiene, isoprene, and chloroprene.

Preferred principal monomers are the C₁ to C₁₀ alkyl acrylates and methacrylates, especially C₁ to C₈ alkyl acrylates and methacrylates, and vinylaromatics, especially styrene, and mixtures thereof.

Very particular preference is given to methyl acrylate, methyl methacrylate, ethyl acrylate, n-butyl acrylate, n-hexyl acrylate, octyl acrylate, and 2-ethylhexyl acrylate, styrene, and mixtures of these monomers.

Besides the principal monomers the polymer may comprise further monomers, examples being monomers with carboxylic acid, sulfonic acid or phosphonic acid groups. Carboxylic acid groups are preferred. Examples that may be mentioned include acrylic acid, methacrylic acid, itaconic acid, maleic acid or fumaric acid.

Further monomers are, for example, monomers comprising hydroxyl groups, especially C₁-C₁₀ hydroxyalkyl (meth)acrylates, and (meth)acrylamide.

Additional further monomers that may be mentioned include phenyloxyethyl glycol mono(meth)acrylate, glycidyl acrylate, glycidyl methacrylate, and amino(meth)acrylates such as 2-aminoethyl (meth)acrylate.

As further monomers mention may also be made of crosslinking monomers.

In one preferred embodiment the polymer comprises hydrophilic groups selected from carboxyl groups, hydroxyl groups, amino groups, and carboxamide groups. The amount of these hydrophilic groups is in particular 0.001 to 0.5 mol per 100 g of polymer. Preferably the amount is at least 0.005 mol, more preferably at least 0.008 mol, and at most 0.2 mol, in particular at most 0.1 mol, with very particular preference at most 0.05 or 0.03 mol per 100 g of polymer.

Particular preference is given to the hydrophilic groups selected from carboxyl groups, hydroxyl groups, and carboxamide groups.

With particular preference at least 20 mol % of the total molar amount of these groups are carboxyl groups.

By carboxyl groups are meant not only carboxylic acid groups but also their salts. In the case of the salts they are preferably salts with volatile bases, ammonia for example.

The hydrophilic groups can be attached to the polymer by copolymerizing the corresponding monomers.

Preferred monomers with hydrophilic groups are the abovementioned monomers with carboxyl groups and hydroxyl groups, a particular example being acrylic acid.

In particular the polymer is composed of at least 60% by weight, more preferably at least 80% by weight, and with very particular preference at least 95% by weight of C₁ to C₂₀ alkyl (meth)acrylates.

The polymer preferably has a glass transition temperature, calculated by the method of Fox from the monomer composition, of −50 to +10° C., more preferably of −40 to +5° C.

The glass transition temperature is calculated by the Fox equation from the glass transition temperature of the homopolymers of the monomers present in the copolymer and their weight fraction:

1/Tg=xA/TgA+xB/TgB+.xC/TgC+ . . .
Tg: calculated glass transition temperature of the copolymer
TgA: glass transition temperature of the homopolymer of monomer A
TgB, Tgs correspondingly for monomers B, C, etc.
xA: mass of monomer A/total mass of copolymer,
xB, xC correspondingly for monomers B, C etc.

The Fox equation is given in customary specialist books, including for example in the Handbook of Polymer Science and Technology, New York, 1989 by Marcel Dekker, Inc.

In one preferred embodiment the polymers are prepared by emulsion polymerization, and the product is therefore an emulsion polymer.

In the case of emulsion polymerization, ionic and/or nonionic emulsifiers and/or protective colloids, or stabilizers, are used as surface-active compounds.

A detailed description of suitable protective colloids is found in Houben-Weyl, Methoden der organischen Chemie, Volume XIV/1, Makromolekulare Stoffe [Macromolecular compounds], Georg-Thieme-Verlag, Stuttgart, 1961, pp. 411 to 420. Suitable protective colloids include for example amphiphilic polymers, i.e., polymers having hydrophobic and hydrophilic groups. These may be natural polymers, such as starch, or synthetic polymers, such as hydrophilically modified polyolefins, acrylic acid/ethylene copolymers for example. Suitable emulsifiers include anionic, cationic, and nonionic emulsifiers. As accompanying surface-active substances it is preferred to use exclusively emulsifiers, whose molecular weights, in contradistinction to those of the protective colloids, are typically below 2000 g/mol. Where mixtures of surface-active substances are used the individual components must of course be compatible with one another, something which in case of doubt can be checked by means of a few preliminary tests. Preference is given to using anionic and nonionic emulsifiers as surface-active substances. Common accompanying emulsifiers are, for example, ethoxylated fatty alcohols (EO degree: 3 to 50, alkyl radical: C₈ to C₃₆), ethoxylated mono-, di-, and trialkylphenols (EO degree: 3 to 50, alkyl radical: C₄ to C₉), alkali metal salts of dialkyl esters of sulfosuccinic acid, and also alkali metal salts and ammonium salts of alkyl sulfates (alkyl radical: C₈ to C₁₂), of ethoxylated alkanols (EO degree: 4 to 30, alkyl radical: C₁₂ to C₁₈), of ethoxylated alkylphenols (EO degree: 3 to 50, alkyl radical: C₄ to C₉), of alkylsulfonic acids (alkyl radical: C₁₂ to C₁₈), and of alkylarylsulfonic acids (alkyl radical: C₉ to C₁₈).

Further suitable emulsifiers are compounds of the general formula II

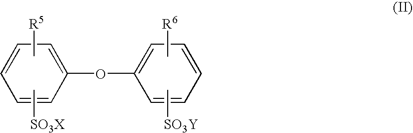

in which R⁵ and R⁶ are hydrogen or C₄ to C₁₄ alkyl and are not simultaneously hydrogen, and X and Y can be alkali metal ions and/or ammonium ions. Preferably R⁵ and R⁶ are linear or branched alkyl radicals having 6 to 18 C atoms or hydrogen and in particular have 6, 12, and 16 C atoms, R⁵ and R⁶ not both simultaneously being hydrogen. X and Y are preferably sodium, potassium or ammonium ions, with sodium being particularly preferred. Particularly advantageous compounds II are those in which X and Y are sodium, R⁵ is a branched alkyl radical having 12 C atoms, and R⁶ is hydrogen or R⁵. Use is made frequently of technical mixtures with have a fraction of 50% to 90% by weight of the monoalkylated product, an example being Dowfax® 2A1 (trademark of the Dow Chemical Company).

Suitable emulsifiers are also found in Houben-Weyl, Methoden der organischen Chemie, Volume 14/1, Makromolekulare Stoffe, Georg Thieme Verlag, Stuttgart, 1961, pages 192 to 208.

Examples of emulsifier trade names include Dowfax® 2 A1, Emulan® NP 50, Dextrol® OC 50, Emulgator 825, Emulgator 825 S, Emulan®p9 OG, Texapon® NSO, Nekanil® 904 S, Lumiten® I-RA, Lumiten® E 3065, Disponil® FES 77, Lutensol® AT 18, Steinapol VSL, and Emulphor NPS 25.

Preference for the present invention is given to ionic emulsifiers or protective colloids. With particular preference they are ionic emulsifiers, especially salts and acids, such as carboxylic acids, sulfonic acids, and sulfates, sulfonates or carboxylates. In one particularly preferred embodiment protective colloids are used, preferably in amounts of 0 to 30 parts by weight, more preferably of 10 to 20 parts by weight, per 100 parts by weight of the monomers to be polymerized.

The surface-active substances in total (i.e., emulsifiers and protective colloids) are used preferably in amounts of 0.1 to 35 parts by weight, preferably 0.2 to 30 parts by weight, based on 100 parts by weight of the monomers to be polymerized.

Protective colloids are preferably introduced as an initial charge for the emulsion polymerization, whereas emulsifiers can also be supplied, together if appropriate with the monomers, in the course of the polymerization.

Water-soluble initiators for the emulsion polymerization are, for example, ammonium salts and alkali metal salts of peroxydisulfuric acid, sodium peroxydisulfate for example, hydrogen peroxide or organic peroxides, tert-butyl hydroperoxide for example.

Also suitable are what are known as reduction-oxidation (redox) initiator systems.

The redox initiator systems are composed of at least one, usually inorganic, reducing agent and an organic or inorganic oxidizing agent.

The oxidizing component comprises, for example, the initiators already stated above for the emulsion polymerization.

The reducing components comprise, for example, alkali metal salts of sulfurous acid, such as sodium sulfite, sodium hydrogen sulfite, alkali metal salts of disulfurous acids such as sodium disulfite, bisulfite addition compounds with aliphatic aldehydes and ketones, such as acetone bisulfite, or reducing agents such as hydroxymethanesulfinic acid and its salts, or ascorbic acid. The redox initiator systems can be used together with soluble metal compounds whose metallic component is able to exist in a plurality of valence states.

Typical redox initiator systems are, for example, ascorbic acid/iron(II) sulfate/sodium peroxydisulfate, tert-butyl hydroperoxide/sodium disulfite, tert-butyl hydroperoxide/Na hydroxymethanesulfinic acid. The individual components, the reducing component for example, may also be mixtures, an example being a mixture of the sodium salt of hydroxymethanesulfinic acid with sodium disulfite.

The stated compounds are used mostly in the form of aqueous solutions, the lower concentration being determined by the amount of water that is acceptable in the dispersion and the upper concentration by the solubility of the respective compound in water. In general the concentration is 0.1 to 30% by weight, preferably 0.5 to 20% by weight, more preferably 1.0 to 10% by weight, based on the solution.

The amount of initiators is generally 0.1 to 10% by weight, preferably 0.5 to 5% by weight, based on the monomers to be polymerized. It is also possible for two or more different initiators to be used in the emulsion polymerization.

In the polymerization it is possible to employ regulators, in amounts for example of 0 to 0.8 part by weight, based on 100 parts by weight of the monomers to be polymerized, and these regulators lower the molar mass. Suitability is possessed for example by compounds containing a thiol group such as tert-butyl mercaptan, thioglycolic acid ethylacrylic ester, mercaptoethynol, mercaptopropyltrimethoxysilane or tert-dodecyl mercaptan.

The emulsion polymerization takes place in general at 30 to 130, preferably 50 to 90° C. The polymerization medium may be composed either of water alone or of mixtures of water and water-miscible liquids such as methanol. Preferably just water is used. The emulsion polymerization can be conducted either as a batch operation or in the form of a feed process, including stages or gradient procedures. Preference is given to the feed process, for which a portion of the polymerization batch is introduced as an initial charge, heated to the polymerization temperature, and partially polymerized, after which the remainder of the polymerization batch, typically by way of two or more spatially separate feed streams, of which one or more comprise the monomers in neat or in emulsified form, is supplied continuously or else in stages.

The polymer is preferably obtainable by multistage emulsion polymerization; accordingly, it is prepared preferably by multistage emulsion polymerization. The polymerization takes place preferably in at least two temporally successive stages, the individual stages differing in the glass transition temperature (Tg) of the monomers polymerized in that stage, as calculated by the method of Fox (and also referred to for short as stage Tg).

The Tg of the last stage is preferably at least 5° C. higher, in particular at least 10° C. higher, than the Tg of the preceding stage.

The Tg of the last stage is in particular greater than 0° C., more preferably greater than 10° C., very preferably greater than 20° C.; it may in particular be greater than 50° C. and may be for example up to 125° C.; in particular it can be about 110° C., if only methyl methacrylate (MMA), for example, is polymerized in the last stage.

The last stage preferably comprises MMA, and with particular preference is composed of at least 20% by weight, in particular at least 25% by weight, or else at least 40% by weight of MMA.

In the case of more than two stages the Tg increases preferably from the first to the last stage.

The polymerization may take place for example in two stages. For the two-stage polymer preferably 50% to 99% by weight, preferably 55% to 75% by weight, of the monomers are polymerized in a first stage. The glass transition temperature of the monomers of this first stage, as calculated by the method of Fox, is −50 to +25° C., preferably −50 to 0° C. In the second stage then 1% to 40% by weight, preferably 25% to 45% by weight, of the monomers are polymerized, the glass transition temperature of the monomers of that stage, as calculated by the method of Fox, being 20 to 125° C., preferably 30 to 110° C.

In one particularly preferred embodiment the polymerization takes place in at least three stages.

In the case of more than two stages nontacky coatings are obtained with an even smaller fraction of hard monomers (monomers with a high Tg). The weight fraction of the stages with a Tg greater than 20° C. in the case of more than two-stage polymers amounts preferably in total to 5% to 40% by weight, more preferably 10% to 30% by weight.

In the case of a three-stage polymerization the monomer amounts and Tgs are preferably as follows:

| | |
|---|---|
| 1st stage: 50% to 90% by weight, | Tg (° C.): −50 to +20 |
| 2nd stage: 2% to 15% by weight, | Tg (° C.): −20 to +30 |
| 3rd stage: 2% to 15% by weight | Tg (° C.): 0 to +125 |

In particular the Tg of the 3rd stage is at least 5° higher than that of the 2nd stage, and that of the 2nd stage is at least 5° higher than that of the 1st stage.

In the case of a four-stage polymerization the monomer amounts and Tgs are preferably as follows:

| | |
|---|---|
| 1st stage: 50% to 80% by weight, | Tg (° C.) −50 to +20 |
| 2nd stage: 2% to 15% by weight | Tg (° C.) −20 to +30 |
| 3rd stage 2% to 15% by weight | Tg (° C.) 0 to 60 |
| 4th stage 2% to 15% by weight | Tg (° C.) 20 to 125 |

In particular the Tg of the 4th stage is at least 5° higher than that of the 3rd stage, and that of the 3rd stage is at least 5° higher than that of the 2nd stage, and that of the 2nd stage is at least 5° higher than that of the 1 st stage.

In the case of the multistage polymerization the polymerization of the monomers of the individual stages takes place during or immediately after the addition of the monomers to the polymerization mixture. In other words, during or directly after the addition of the monomers, the conditions are such that the added monomers undergo polymerization. For this purpose there ought in particular to be an initiator present and the temperature ought to be sufficiently high. With particular preference initiator is added synchronously with the addition of monomer. If the monomers of a stage are supplied continuously over a relatively long time period, it is preferred to supply initiator for at least the same time period. Since the supplied monomers undergo polymerization during or immediately after their addition, the swelling polymerization described for example in EP-A 1 420 055 does not occur.

In order to remove the residual monomers it is usual to add initiator also after the end of the emulsion polymerization proper.

By the above multistage emulsion polymerization a polymer is obtainable in particular which is nontacky at 20° C. and which has a glass transition temperature of all monomers of which the polymer is composed, calculated by the method of Fox, of −50 to +10° C., and is of at least two-stage composition, wherein the polymerization takes place in at least two temporally successive stages, the individual stages differing in the glass transition temperature (Tg) of the monomers, as calculated by the method of Fox, and the Tg of the last stage being at least 0° C.

In the emulsion polymerization aqueous dispersions of the polymer are obtained with solids contents generally of 15% to 75% by weight, preferably of 40% to 75% by weight.

For a high reactor space/time yield preference is given to dispersions having a very high solids content. In order to be able to achieve solids contents >60% by weight, a bimodal or polymodal particle size ought to be set, since otherwise the viscosity becomes too high and the dispersion can no longer be handled. The production of a new particle generation can be accomplished, for example, by addition of seed (EP 81083), by addition of excess quantities of emulsifier, or by addition of miniemulsions. A further advantage associated with the low viscosity at high solids content is the improved coating performance at high solids contents. One or more new particle generations can be produced at any point in time. The particular point in time is guided by the target particle size distribution for a low viscosity.

The polymer thus prepared is used preferably in the form of its aqueous dispersion.

The average size of the polymer particles dispersed in the aqueous dispersion is preferably less than 400 nm, in particular less than 300 nm. With particular preference the average particle size is situated between 140 and 250 nm.

By average particle size here is meant the d₅₀ value of the particle size distribution; that is, 50% by weight of the total mass of all particles have a diameter smaller than the d₅₀ value. The particle size distribution can be determined conventionally using the analytical ultracentrifuge (W. Mäschtle, Makromolekulare Chemie 185 (1984), page 1025-1039).

The pH of the polymer dispersion is set preferably at a pH greater than 2, in particular at a pH of between 4 and 8.

For the inventive utility the composition may be composed solely of the polymer. Alternatively it may comprise further additives as well, examples being fillers, dyes, flow control agents, or thickeners.

The composition or polymer is autoadhesive. Although the surface of the polymer is of low or no tack, the polymer can be adhered to itself. On even slight contact between two substrates coated with the polymer, both substrates adhere to one another by their coated sides.

Two polyester substrates (polyethylene terephthalate, PET) coated with the composition adhere to one another in particular even on pressing at 20° C., with a peel strength greater than 1 N/2.5 cm, preferably greater than 2 or greater than 3 N/2.5 cm. The peel strength is determined by the following measurement method:

The dispersions or solutions of the polymer are knifecoated at 30 g/m2 (solids) onto sections of PET film 25 mm wide, and drying is carried out at 90° C. for 3 minutes. One test strip are placed with the coated side against one another and sealed with a pressure of 4 bar (at 20° C., i.e., cold sealing). The strip is then clamped with one end into the upper jaws of a tension/extension testing apparatus. The adhesive strip is removed at 300 mm/min and at an angle of 180° from the test surface (V2A stainless steel), i.e., the adhesive strip was bent around and removed parallel to the metal test plate, and the force required to achieve this was measured. The measure of the peel strength is the force in N/2.5 cm which resulted as the average value from five measurements (corresponding to AFERA Standard Method). The peel strength is determined immediately after bonding.

The adhesion is increased by stronger pressing or by an increase in temperature.

The composition of the invention, or the polymer, can therefore be used as an adhesive for the hot or cold sealing of, for example, packaging.

The composition of the invention is particularly suitable as an adhesive for cold sealing. By cold sealing is meant a method in which the temperature in the adhesive layer (and preferably also the temperature of the substrate to be bonded) is less than 40° C., in particular less than 30° C. or less than 25° C. In general cold sealing is carried out at the prevailing room temperature, in other words generally at temperatures from 10 to 30° C., in particular 15 to 25° C. The substrates are preferably contacted under pressure. Suitable pressures are those of just a few millibar up to a number of bar above normal pressure (1 bar); mention may be made of pressures from 0.01 to 5 bar, in particular of 0.1 to 3 bar above normal pressure. The sealing time (time during which the temperature, and, if appropriate, the pressure are maintained) is for example 0.1 to 20 seconds, in particular 0.1 to 3 seconds, with 0.5 second, in particular, being typical.

The composition of the invention is suitable for joining two arbitrary substrates, for which
the two substrates are coated with the composition of the invention at the locations that are to be bonded, and
the two substrates are contacted under pressure if appropriate, and the temperature in the coated composition is less than 40° C. (cold sealing; see above).

The substrates to be bonded are arbitrary, examples being substrates of wood, metal, paper or plastic, which may be bonded to one another in any desired combination.

For this purpose the substrates are coated with the composition of the invention. Coating may take place in a conventional manner; typical coat thicknesses (after drying) are for example 1 to 30 g/m², preferably 3 to 30 g/m².

The composition of the invention is particularly suitable for producing packaging. The packaging in question here is that of any desired materials, such as of paper or, preferably, of plastic, for example. Mention may be made, for example, of packaging made of polymer films, including, if appropriate, metallized polymer films, examples being films of polyethylene, polypropylene, PVC, polyester, polyacetate.

Particularly suitable for producing packaging is a double-sidedly coated support, the support having on one side (referred to below as the front face) an outer layer of the composition of the invention, and on the other side (referred to below as the back face) an outer release coating.

The support may be composed, for example, of one of the abovementioned polymer films, or metallized polymer films; mention may be made in particular of films of oriented polypropylene, polyethylene, preferably high-density polyethylene, or polyethylene terephthalate. The polymer films may also have been corona-pretreated.

The composition of the invention can be coated directly onto the front face of the support, although it is also possible for other layers to be present between the support and the composition of the invention, examples being primer layers or printing-ink layers (colored or black/white images). It is important that the layer of the composition of the invention is on the outside.

The release coating may be of any desired material, and may comprise a polymer film, e.g., a film of oriented polypropylene, which is laminated on or coextruded, or a liquid varnish, e.g., a polyamide varnish, which is applied and filmed; it is important that the layer of adhesive applied to the front face of the support (in the present case, this layer is the composition of the invention) does not adhere to the release coating (blocking resistance). The support is generally rolled up and later processed from the roll. In the course of rolling up, the front face and the back face of the support come into direct contact. Adhesion of the front face to the back face will render the support unusable.

There may be further layers between the release coating and the support; suitable such layers include, in turn, layers of a primer which improves the adhesion, and printing-ink layers. The outer release coating also has the function of protecting the lower layers, particularly the printing-ink layer, against external exposures.

Preferred supports have the following construction, the sequence of the layers corresponding to the arrangement in space:

adhesive layer (composition of the invention)
support
if appropriate, primer layer
if appropriate, printing-ink layer
release coating

The double-sidedly coated support is used in particular for producing packaging, for which purpose it is preferably bonded to itself by cold sealing, (with the front faces in each case being brought into contact with the outer composition of the invention). It is important here that both substrates to be bonded are coated at the points to be bonded (sealing seam) with the composition of the invention. The packaging is sealed by hot or preferably cold sealing of the adhesive layer to one another as soon as the product to be packed has been introduced.

The packaging is particularly suitable for foodstuffs.

### EXAMPLES

### Example 1

### Preparation of a Two-Stage Polymer

Solids content: 57.00%
Monomer amount: 800.00 g

Initial charge

| Amount | ingredient |
|---|---|
| Total: | 135.76 g |
| 106.50 g | DI water |
| 12.12 g | seed T 6772 (33% in water) |
| 17.14 g | sodium peroxodisulfate (7%) |

Feed stream 1

| | |
|---|---|
| Total: | 976.52 g |
| 319.00 g | DI water |
| 17.50 g | Dowfax 2A1 (emulsifier) |
| 640.00 g | n-butyl acrylate |

Feed stream 2

| | |
|---|---|
| Total: | 244.10 g |
| 71.60 g | DI water |
| 12.50 g | Dowfax 2A1 |
| 80.00 g | methyl methacrylate |
| 80.00 g | methyl acrylate |

Feed stream 3

| | |
|---|---|
| Total: | 10.00 g |
| 10.00 g | acetone bisulfite |

Feed stream 4

| | |
|---|---|
| Total: | 24.00 g |
| 24.00 g | tert-butyl hydroperoxide (10% strength) |

Feed stream 5

| | |
|---|---|
| Total: | 12.00 g |
| 12.00 g | sodium hydrogen carbonate |

Feed stream 6

| | |
|---|---|
| Total: | 12.00 g |
| 12.00 g | tert-butyl hydroperoxide |

Feed stream 7

| | |
|---|---|
| Total: | 8.89 g |
| 8.89 g | Rongalit C |

Feed stream 8

| | |
|---|---|
| Total: | 32.00 g |
| 32.00 g | sodium hydrogen carbonate |

The initial charge was heated to 80° C. Then feed stream 1, feed stream 3, feed stream 4, and feed stream 5 were commenced. Feed stream 1 was metered in over 2 h and polymerized subsequently for 45 min. Thereafter feed stream 2 was metered in over 45 min and polymerized subsequently for 30 min. Feed stream 3, feed stream 4, and feed stream 5 were metered in over 4 h. Thereafter feed stream 6 and feed stream 7 were run in over 1 h. After the batch had been cooled to room temperature, it was adjusted with feed stream 8 to a pH of 6 to 8.

### Example 2

### Preparation of a Three-Stage Polymer

Solids content: 54.00%

Initial charge

| Amount | ingredient |
|---|---|
| Total: | 207.30 g |
| 39.04 g | DI water |
| 0.76 g | seed T 6772 |
| 150.00 g | C*Plus 10998 |
| 12.50 g | water peroxide |
| 5.00 g | Dissolvine E-Fe 13 |

Partial additional amounts

| | |
|---|---|
| In initial charge | 9.38 g of feed stream 4 |
| Residual feed stream | 84.38 g of feed stream 4 |

Feed stream 1

| | |
|---|---|
| Total: | 628.91 g |
| 189.80 g | DI water |
| 5.78 g | Disponil FES 77 (30% strength) |
| 370.00 g | n-butyl acrylate |
| 63.33 g | methyl methacrylate |

Feed stream 2

| | |
|---|---|
| Total: | 48.38 g |
| 14.60 g | DI water |
| 0.44 g | Disponil FES 77 (30% strength) |
| 23.33 g | n-butyl acrylate |
| 10.00 g | methyl methacrylate |

Feed stream 3

| | |
|---|---|
| Total: | 48.38 g |
| 14.60 g | DI water |
| 0.44 g | Disponil FES 77 (30% strength) |
| 16.67 g | n-butyl acrylate |
| 16.67 g | methyl methacrylate |

Feed stream 4

| | |
|---|---|
| Total: | 93.75 g |
| 93.75 g | ascorbic acid (2% strength) |

Feed stream 5

| | |
|---|---|
| Total: | 3.33 g |
| 3.33 g | hydrogen peroxide (30% strength) |

Feed stream 6

| | |
|---|---|
| Total: | 30.00 g |
| 30.00 g | ascorbic acid (5% strength) |

Feed stream 7

| | |
|---|---|
| Total: | 33.33 g |
| 33.33 g | Steinapol NLS (15% strength) |

The initial charge was heated to 70° C.; at 70° C. the partial amount of feed stream 4 was added over 2 min and polymerized for 3 min. Thereafter feed stream 1 and residual amount of feed stream 4 were commenced. Feed stream 1 was run in over 2 h 10 min, after which feed stream 2 was metered in over 10 min and feed stream 3 over 10 min. The residual amount of feed stream 4 was metered in over 3 h during this time. Feed stream 5 was added in 1 min. Feed stream 6 was run in over 1 h. Feed stream 7 was added, and then the batch was cooled.

### Example 3

### Preparation of a Four-Stage Polymer

Solids content: 51.00%
Monomer amount: 500.00 g

Initial charge

| Amount | ingredient |
|---|---|
| Total: | 307.48 g |
| 84.30 g | DI water |
| 1.52 g | seed T 6772 (33% strength) |
| 200.00 g | C*Plus 10998 (50% strength) |
| 16.67 g | water peroxide (30% strength) |
| 5.00 g | Dissolvine E-Fe 13 (1% strength) |

Partial additional amounts

| | |
|---|---|
| In initial charge | 12.50 g of feed stream 5 |
| Residual feed stream | 112.50 g of feed stream 5 |

Feed stream 1

| | |
|---|---|
| Total: | 585.46 g |
| 180.92 g | DI water |
| 1.33 g | Disponil FES 77 (30% strength) |
| 3.20 g | ammonia (25% strength) |
| 360.00 g | n-butyl acrylate |
| 40.00 g | methyl methacrylate |

Feed stream 2

| | |
|---|---|
| Total: | 48.79 g |
| 15.08 g | DI water (100%) |
| 0.11 g | Disponil FES 77 (30%) |
| 0.27 g | ammonia (25%) |
| 23.33 g | n-butyl acrylate (100%) |
| 10.00 g | methyl methacrylate (100%) |

Feed stream 3

| | |
|---|---|
| Total: | 48.79 g |
| 15.08 g | DI water (100%) |
| 0.11 g | Disponil FES 77 (30%) |
| 0.27 g | ammonia (25%) |
| 16.67 g | n-butyl acrylate (100%) |
| 16.67 g | methyl methacrylate (100%) |

Feed stream 4

| | |
|---|---|
| Total: | 48.79 g |
| 15.08 g | DI water (100%) |
| 0.11 g | Disponil FES 77 (30%) |
| 0.27 g | ammonia (25%) |
| 10.00 g | n-butyl acrylate (100%) |
| 23.33 g | methyl methacrylate (100%) |

Feed stream 5

| | |
|---|---|
| Total: | 125.00 g |
| 125.00 g | ascorbic acid (1%) |

Feed stream 6

| | |
|---|---|
| Total: | 3.33 g |
| 3.33 g | water peroxide (30% strength) |

Feed stream 7

| | |
|---|---|
| Total: | 30.00 g |
| 30.00 g | ascorbic acid (5% strength) |

The initial charge is heated to 80° C. At 80° C. the partial amount of feed stream 5 is added in 2 min and polymerized for 3 min. Thereafter feed stream 1 is added over 2 h and the residual amount. Feed stream 2 is metered in over 10 min. Feed stream 3 is metered in over 10 min. Feed stream 4 is metered in over 10 min. Feed stream 5 is metered in over 3 h during this time. Polymerization takes place subsequently for 30 min. Feed stream 6 is added in 1 min. Feed stream 7 was run in over 1 h, and then the batch was cooled to room temperature.

The composition of the polymers was as follows (amounts in % by weight, based on the polymer):

| | | n-Butyl | Methyl | Methyl | |
|---|---|---|---|---|---|
| | | acrylate | methacrylate | acrylate | Polymer |
| | | (BA) | (MMA) | (MA) | Tg (° C.) |
| Polymer 1 | total | 80.0 | 10.0 | 10.0 | |
| | 1st stage | 80.0 | — | — | −43.0 |
| | 2nd stage | — | 10.0 | 10.0 | +58.4 |
| Polymer 2 | total | 82.0 | 18.0 | — | |
| | 1st stage | 74.0 | 12.7 | — | −29.0 |
| | 2nd stage | 4.7 | 2.0 | — | −12.4 |
| | 3rd stage | 3.3 | 3.3 | — | +13.0 |
| Polymer 3 | total | 58.0 | 42.0 | — | |
| | 1st stage | 50.0 | 30.0 | — | −3.4 |
| | 2nd stage | 3.7 | 3.0 | — | +6.2 |
| | 3rd stage | 2.3 | 4.3 | — | +35.5 |
| | 4th stage | 2.0 | 4.7 | — | +43.8 |

The performance properties were determined by the measurement methods specified in the description.

Peel strength against steel (blocking resistance test, demonstration of nontackiness):

| | | | Peel strength |
|---|---|---|---|
| Sample | Stage | Substrate | (N/2.5 cm) |
| Polymer 1 | 2-stage | steel | 0.15 |
| Polymer 2 | 3-stage | steel | 0.05 |
| Polymer 3 | 4-stage | steel | 0.00 |

Loop values against steel (blocking resistance test, demonstration of nontackiness):

| | | | Loop values |
|---|---|---|---|
| Sample | Stage | Substrate | (N/2.5 cm) |
| Polymer 1 | 2-stage | steel | 0.15 |
| Polymer 2 | 3-stage | steel | 0.00 |
| Polymer 3 | 4-stage | steel | 0.00 |

Peel strength (autoadhesion test, cold sealing):

| | | | Peel strength |
|---|---|---|---|
| Sample | Stage | Substrate | (N/2.5 cm) |
| Polymer 1 | 2-stage | itself | 2.93 |
| Polymer 2 | 3-stage | itself | 4.65 |
| Polymer 3 | 4-stage | itself | 1.40 |

### Cold Sealing

The support used was a film of oriented polypropylene (oPP, optionally corona-pretreated, see table). The film was coated on the reverse face with a release varnish (0.07 mm wire doctor, 1.0 g/m² polyamide solution) and dried with a hot air blower for 10 seconds.

On the front face a polymer dispersion from example 2 (inventive) or, in the comparative example, a natural rubber (which has been used to date for cold sealing) was applied (0.1 mm wire doctor, for coatweight see table) and was dried at 70° C. for 1 minute.

### Tests:

### Sealing Seam Strength

Strips 15 mm wide were cut from the double-sidedly coated oPP films; two strips were placed with the adhesive side against one another and were sealed on the sealing apparatus at 2.1 bar for 0.5 second. Immediately after sealing, the peel strengths in N/15 mm were determined with a pull-off speed of 50 mm/min.

### Blocking Test

The double-sidedly coated oPP films were placed with the release coating side against the adhesive side and subjected to a 10 metric ton weight load for 24 hours; thereafter the peel strength in N/25 mm was determined with a pull-off speed of 800 mm/min. As far as possible the adhesive side ought not to adhere to the release coating, and so the peel strength obtained should be as small as possible.

### Results.

| | Comparative | | | | |
|---|---|---|---|---|---|
| | example | | Inventive | | |
| pH | 9.84 | 9.84 | 2.01 | 6.07 | 10.04 |
| Viscosity (mPas) | 48 | 48 | 153 | 125 | 35 |
| OPP corona-pretreated | yes | no | yes | yes | yes |
| Coatweight of adhesive | 3.08 | 2.82 | 2.75 | 2.55 | 2.61 |
| in g/m² | | | | | |
| Sealing seam strength | 1.31 | 0.27 | 1.07 | 1.31 | 1.22 |
| immediately | | | | | |
| Sealing seam strength | 1.42 | 0.56 | 1.11 | 1.40 | 1.52 |
| after 1 day | | | | | |
| Blocking test | 0.05 | 0.03 | 0.06 | 0.09 | 0.10 |

1. The method of using a composition of low or no tack at 20° C. as an adhesive that can be adhered to itself (referred to below for short as an autoadhesive).

2. The method according to claim 1, wherein a polyethylene substrate coated with the composition has an adhesion to steel at 20° C. of less than 0.5 N/2.5 cm.

3. The method according to claim 1, wherein the composition comprises an aqueous polymer dispersion as binder.

4. The method according to claim 1, wherein the dispersed polymer is composed of at least 60% by weight of principal monomers selected from C1 to C20 alkyl (meth)acrylates, vinyl esters of carboxylic acids comprising up to 20 C atoms, vinylaromatics having up to 20 C atoms, ethylenically unsaturated nitrites, vinyl halides, vinyl ethers of alcohols comprising 1 to 10 C atoms, aliphatic hydrocarbons having 2 to 8 C atoms and one or two double bonds, or mixtures of these monomers.

5. The method according to claim 1, wherein the polymer is composed of more than 60% by weight of C1 to C20 alkyl (meth)acrylates.

6. The method according to claim 1, wherein the glass transition temperature of all monomers of which the polymer is composed is 50 to +10° C. as calculated by the method of Fox.

7. The method according to claim 1, wherein the dispersed polymer is obtainable by multistage emulsion polymerization.

8. The method according to claim 1, wherein the polymerization takes place in at least two temporally successive stages, the individual stages differing in the glass transition temperature (Tg) of the monomers polymerized in that stage, as calculated by the method of Fox (and also referred to for short as stage Tg), and the Tg of the last stage being greater than 0° C.

9. The method as claimed in claim 1, wherein the Tg of the last stage is at least 5° C. higher than the Tg of the preceding stage.

10. The method according to claim 1, wherein the Tg of the stages increases from the first to the last stage.

11. The method according to claim 1, wherein the polymerization takes place in two stages, 60% to 99% by weight of the monomers being polymerized in a first stage and the glass transition temperature of the monomers of this stage, as calculated by the method of Fox, being from −50 to +5° C., and 1% to 40% by weight of the monomers being polymerized in a second stage, the glass transition temperature of the monomers of this stage, as calculated by the method of Fox, being 20 to 125° C., and the glass transition temperature of the monomers of the 2nd stage being at least 5° higher than that of the first stage.

12. The method according to claim 1, wherein the polymerization takes place in at least three stages, the weight fraction of the stages with a Tg greater than 0° C. amounting in total to 5% to 40% by weight.

13. The method according to claim 1, wherein the polymerization takes place in three stages, the monomer amounts and Tgs being as follows:

| | | | |
|---|---|---|---|
| 1st stage: | 50% to 90% by weight, | Tg (° C.): | −50 to +20 |
| 2nd stage: | 2% to 15% by weight, | Tg (° C.): | −20 to +30 |
| 3rd stage: | 2% to 15% by weight | Tg (° C.): | 0 to +125 |

and the Tg of the 3rd stage is at least 5° higher than that of the 2nd stage, and that of the 2nd stage is at least 5° higher than that of the 1st stage.

14. The method according to claim 1, wherein the polymerization takes place in four stages, the monomer amounts and Tgs being as follows:

| | | | |
|---|---|---|---|
| Claim 1st stage: | 50% to 80% by weight, | Tg (° C.) | −50 to +20 |
| 2nd stage: | 2% to 15% by weight | Tg (° C.) | −20 to +30 |
| 3rd stage: | 2% to 15% by weight | Tg (° C.) | 0 to 60 |
| 4th stage: | 2% to 15% by weight | Tg (° C.) | 20 to 125 |

and the Tg of the 4th stage being at least 5° higher than that of the 3rd stage, and that of the 3rd stage being at least 5° higher than that of the 2nd stage, and that of the 2nd stage being at least 5° higher than that of the 1st stage.

15. The method according to claim 1, wherein the polymerization of the monomers of the individual stages takes place during or immediately after the addition of the monomers to the polymerization mixture.

16. The method of the composition as an adhesive for the hot or cold sealing of packaging.

17. A method of joining two substrates, which comprises
coating the two substrates at the locations to be bonded with a composition according to claim 1 and
contacting the two substrates under pressure if appropriate,
the temperature in the coated composition being less than 40° C. (cold sealing).

18. A double-sidedly coated support, wherein the support on one side (referred to below as the front face) has an outer layer of the composition according to claim 1 and on the other side (referred to below as the back face) has an outer layer of a release coating.

19. The method of using the support according to claim 18 for producing packaging.

20. A polymer of low or no tack at 20° C. which is obtainable by multistage emulsion polymerization, with a glass transition temperature of all monomers of which the polymer is composed, calculated by the method of Fox, of −50 to +10° C., wherein the polymerization takes place in at least two temporally successive stages, the individual stages differing in the glass transition temperature (Tg) of the monomers, as calculated by the method of Fox, and the Tg of the last stage being at least 0° C.
